(19) United States
(12) Patent Application Publication
(10) Pub. No.: US 2003/0231390 A1
(43) Pub. Date: Dec. 18, 2003

(54) Athermal delay line

(76) Inventors: Steven J. Wein, Sudbury, MA (US); David J. Korwan, Westford, MA (US); Charles D. Houghton, Manchester, MA (US); James D. Targove, Sudbury, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/389,706

(22) Filed: Mar. 14, 2003

Related U.S. Application Data
(60) Provisional application No. 60/364,958, filed on Mar. 15, 2002.

(51) Int. Cl. G02B 5/30; G02B 27/28

(52) U.S. Cl. 359/495

(57) ABSTRACT

An athermalized delay line having two optical paths whose difference in optical path length is thermally insensitive. Each optical path typically includes a reflecting quarterwave plate, each path being fed by the output from a polarizing beamsplitter. The delay line is suitable for incorporation into a PMD compensator having at least one compensation stage formed from a polarization controller and an athermalized delay line.

### CROSS-REFERENCE TO RELATED APPLICATIONS

The present application claims the benefit of co-pending U.S. provisional application No. 60/364,958, filed on Mar. 15, 2002 and assigned to Terapulse, Inc., the entire disclosure of which is incorporated by reference as if set forth in its entirety herein.

### FIELD OF THE INVENTION

The present invention relates to optical devices, and, in particular, to a thermally insensitive delay line.

### BACKGROUND OF THE INVENTION

Birefringence, also known as “double refraction,” occurs in a material whose index of refraction varies with the orientation of its crystalline lattice relative to incident light. When light enters a birefringent material along a non-equivalent axis, it is refracted into two orthogonally polarized rays traveling at different velocities.

An ideal optical fiber is isotropic, i.e., having an index of refraction that is independent of the orientation of the crystal lattice with respect to incident light, and therefore non-birefringent. Light propagation in a single-mode fiber is governed by two or more fundamental or “principal” modes which, in an ideal fiber, are degenerate (i.e., indistinguishable). These modes are known as “principal states of polarization” (PSPs).

However, birefringence may arise in optical fibers as the fiber core becomes eccentric due to manufacture, stress, and/or vibration. Eccentricity causes birefringence and, therefore, loss of degeneracy between the two principal states. As a result, in a typical optical fiber carrying an optical signal, the principal modes of the signal travel at different speeds and the individual pulses in the signal separate into two slightly displaced pulses. This spreading causes the adjacent pulses in a data stream to overlap, resulting in data ambiguity or loss—a condition known as “polarization mode distortion” (PMD). The spread between the two PSPs is known as the “differential group delay” (DGD).

A typical method for PMD compensation utilizes one or more compensation stages, with each stage having a polarization controller, a delay line, a PMD monitor, and a controller to compute settings for the polarization controller. Determining appropriate polarization controller settings typically involves accurate measurements of the polarization transfer properties of the elements in the compensation stages. However, a delay line constructed from polarization-maintaining fiber (PMF) typically has sufficient temperature sensitivity that temperature variations of less than one degree Celsius will render these measurements inaccurate.

A need therefore exists for a delay line whose retardance varies at most by several degrees over a wide range of temperatures.

### SUMMARY OF THE INVENTION

The present invention relates to apparatus implementing athermalized delay lines. These athermalized delay line structures have sufficient thermal insensitivity to permit PMD compensation in a single deterministic step, avoiding the use of iterative compensation algorithms.

In one aspect, the present invention provides an athermal delay line having a first optical path and a second optical path, with the difference in optical path length between the first optical path and the second optical path being thermally insensitive. The overlapping portion of the first and second optical paths may include a polarizing beam splitter or, optionally, a fold mirror (e.g., an angled glass facet, a beamsplitter cube with a reflective coating on its hypotenuse, or a free space mirror).

In a typical embodiment, each optical path includes a reflecting quarterwave plate, such as a quarterwave plate having a reflective coating or, alternately, a quarterwave plate in non-adjacent proximity to a reflector. In another embodiment, the delay line further includes a transmissive quarterwave plate at the input or output ports of the delay line. The non-overlapping portion of the first optical path and the second optical path may include an air gap.

In another aspect, the present invention provides an apparatus for delaying a light signal including a polarizing beamsplitter, a first optical path formed by a first reflecting quarterwave plate and the beamsplitter, and a second optical path formed by a second reflecting quarterwave plate and the beamsplitter, with the difference in optical path length between the first optical path and the second optical path being thermally insensitive.

The overlapping portion of the first and second optical paths may include a fold mirror (e.g., an angled glass facet, a beamsplitter cube with a reflective coating on its hypotenuse, or a free space mirror). Typical reflecting quarterwave plates include quarterwave plates having reflective coatings or, alternately, quarterwave plates in non-adjacent proximity to reflectors. In another embodiment, the delay line further includes a transmissive quarterwave plate at the input or output ports of the delay line. The non-overlapping portion of the first optical path and the second optical path may include an air gap.

In still another aspect, the present invention provides a PMD compensation stage including a polarization controller and an athermal delay line in optical communication with the polarization controller. The athermal delay line has a first optical path and a second optical path with the difference in optical path length between the first optical path and the second optical path being thermally insensitive.

In yet another aspect, the present invention provides a multichannel PMD compensation stage including a multichannel polarization controller and a multichannel athermal delay line in optical communication with the polarization controller. The athermal delay line has a first optical path and a second optical path, with the difference in optical path length being thermally insensitive.

The foregoing and other features and advantages of the present invention will be made more apparent from the description, drawings, and claims that follow.

### BRIEF DESCRIPTION OF THE DRAWINGS

The advantages of the invention may be better understood by referring to the following description taken in conjunction with the accompanying drawings in which:

FIG. 1 presents the Poincaré sphere representation of polarization state;

FIG. 2 depicts an exemplary second-order PMD compensator;

FIG. 3 illustrates a prior art thermally-sensitive delay line;

FIG. 4 presents an embodiment of an athermal polarization delay line in accord with the present invention;

FIG. 5 depicts another embodiment of an athermal polarization delay line having a fold mirror facet in accord with the present invention;

FIG. 6 illustrates a further embodiment of an athermal polarization delay line with the delay paths of the embodiment of FIG. 4 reversed in accord with the present invention;

FIG. 7 presents still another embodiment of an athermal polarization delay line lacking a fold mirror in accord with the present invention;

FIG. 8 depicts yet another embodiment of an athermal polarization delay line having a second athermalized spacer;

FIG. 9 presents still another embodiment of an athermal polarization delay line having a quarterwave plate at its input/output port in accord with the present invention;

FIG. 10 illustrates a compensation stage utilizing a polarization controller and the athermal delay line of FIG. 4 and having a return path around the polarization controller in accord with the present invention;

FIG. 11 presents another compensation stage utilizing a polarization controller and the athermal delay line of FIG. 6 and having a return path around the polarization controller in accord with the present invention;

FIG. 12 depicts still another compensation stage utilizing a polarization controller and the athermal delay line of FIG. 4 and having a return path through a passive section of the polarization controller in accord with the present invention;

FIG. 13 illustrates a solid state implementation of a second-order PMD compensator utilizing an athermal delay line in accord with the present invention;

FIG. 14 presents another solid state implementation of a second-order PMD compensator utilizing an athermal delay line and having two polarization controllers implemented in a single component in accord with the present invention;

FIG. 15 depicts a multichannel, multistage polarization controller with two polarization controllers per channel in a common component;

FIG. 16 presents a side view of a PMD compensator using the combination of the multichannel, multistage polarization controller of FIG. 14 with an athermal delay line in accord with the present invention; and

FIG. 17 presents another solid state implementation of a second-order PMD compensator utilizing the athermal delay line of FIG. 8 and having two polarization controllers implemented in a single component in accord with the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

In brief overview, the present invention provides apparatus implementing athermalized delay lines suitable for use in PMD compensators. The delay lines have two optical paths that each include an equal optical path length segment, i.e., having the same product of distance times refractive index. These segments may be shared or separate and may be formed from thermally insensitive or thermally sensitive materials, as long as the thermal sensitivity is balanced between the two paths. A differential segment, which implements the delay, has an optical path length that is thermally insensitive, rendering the delay line thermally insensitive. The differential segment may be implemented using, e.g., a thermally-insensitive spacer or by attaching the individual components of the segment to a thermally-insensitive substrate.

Generally speaking, measurements of polarization state are typically expressed using one or more agreed-upon formalisms. One such formalism is a Stokes vector, a four-entry column vector that describes a polarization state. The entries in a Stokes vector reflect the intensity of the incident light as if it was measured through various polarizing devices. For an archetypal Stokes vector S:

$$S = [ \begin{matrix}2 {I}_{0 } \\ 2 {I}_{1} - 2 {I}_{0} \\ 2 {I}_{2} - 2 {I}_{0} \\ 2 {I}_{3} - 2 {I}_{0}\end{matrix} ] = [ \begin{matrix}{S}_{0} \\ {S}_{1} \\ {S}_{2} \\ {S}_{3}\end{matrix} ] \qquad ( Eq . 1 )$$

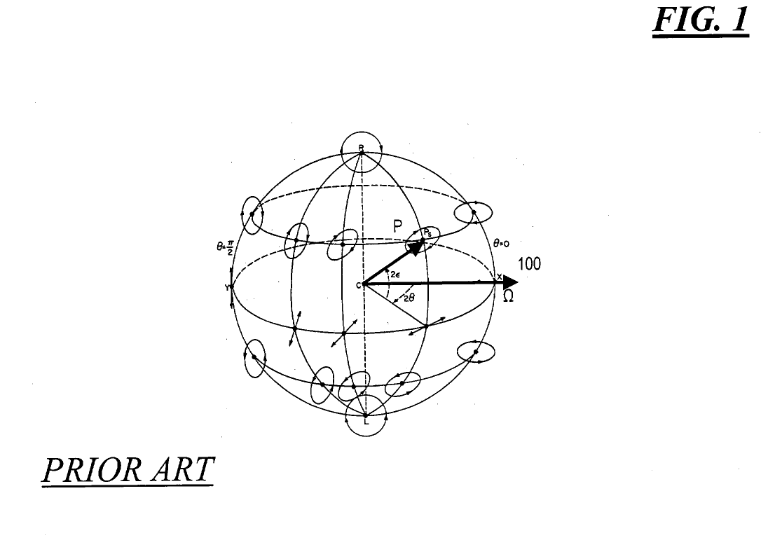

The first parameter, I₀, is the intensity of the light measured through a 50% transmitting filter. The second parameter, I₁, is the intensity of the light measured through a perfect horizontal linear polarizer. The third parameter, I₂, is the intensity of the light measured through a perfect linear polarizer with its transmission axis at 45° from the horizontal axis. The last parameter, I₃, is the intensity measured through a perfect right circular polarization filter. Referring to FIG. 1 for illustrative purposes, each polarization state is conveniently represented as a Stokes vector S, which can be plotted as a point on the surface of a Poincaré sphere 100.

On the Poincaré sphere 100, the PMD of a channel measured at a particular point may be represented by a PMD vector Ω beginning at the sphere's origin and aligned with one of the PSPs of the channel. The vector's magnitude equals one-half the channel's differential group delay. To a first-order approximation, the vector Ω is constant in magnitude and orientation with frequency. However, the PMD of the channel—and therefore the channel DGD and PSPs—is typically frequency dependent. On the Poincaré sphere 100 of FIG. 1, the variation in DGD with frequency appears as a variation in the length of the PMD vector Ω with frequency. Likewise, the variation in PSP with frequency appears as a variation in the orientation of the Ω vector with frequency.

Correcting for PMD effects typically requires accurate measurements of the polarization properties of incident light. Current approaches to polarization measurement are electronic and optical in nature. Certain methods of measuring and compensating for polarization mode dispersion are described in pending U.S. patent application Ser. Nos. 10/101,427, 10/218,681, and 10/259,171, assigned to Terapulse, Inc., the entire contents of which are incorporated herein by reference.

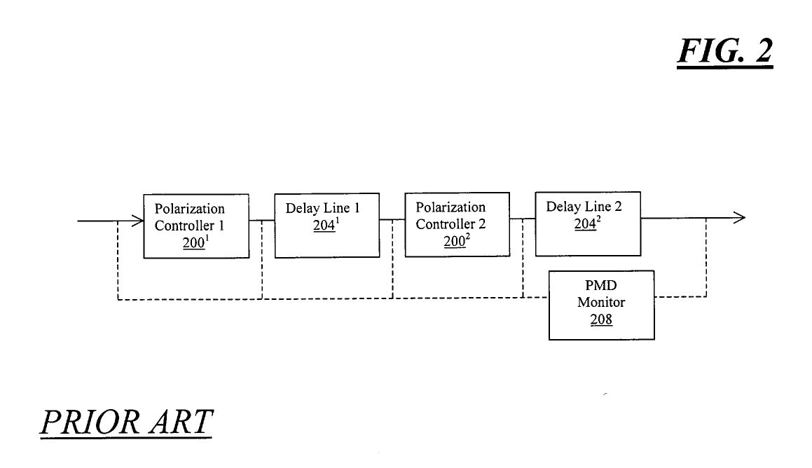

A typical method for PMD compensation utilizes one or more compensation stages, with each stage having a polarization controller and a polarization delay line. An exemplary apparatus having two stages is illustrated in FIG. 2. The first stage includes a first polarization controller 200¹ (generally 200) and a first delay line 204¹ (generally 204). The second stage includes a second polarization controller 200² and a second delay line 204². The second-order PMD compensator of FIG. 2 may be extended to form a higher order compensator by adding additional compensation stages.

A polarization controller 200 converts the polarization state of an incident light into a second, known polarization state. A polarization delay line 204 is in optical communication with the polarization controller 200. The delay line 204 has a differential optical path length, i.e., a differential group delay (DGD), for the two incident, orthogonal polarization states. These polarization eigenstates may be orthogonal linear or circular polarization states with the fastest and slowest propagation through the line 204. The value of the delay may be fixed or variable for each delay line component 204.

Each stage may include a PMD monitor 208^{N} or a controller (not shown). Optionally, as illustrated in FIG. 2, the compensation stages may share a single PMD monitor 208 or a single controller; the tap for the monitor 208 may be located at any of the dotted locations. The PMD monitor 208 may directly measure the PMD properties of its input optical channels, or it may provide an indirect figure of merit such as Degree of Polarization measurements. These measurements, direct or indirect, may subsequently be used in a feedback loop to correct for the effects of PMD in the optical link. The controller computes the settings for the polarization controllers 200 and the delay value for any variable delay line 204 using the measurements from the PMD monitor 208. A controller may be implemented using hardware, software, or a combination thereof.

A typical controller executing a PMD compensation algorithm will compute a frequency-dependent function Ω_{comp(f)} using the measurements from the PMD monitor 208. The Ω_{comp(f)} function may be used to compute controller settings that, when applied to the optical link using a compensation apparatus, best compensates for the PMD present in the optical link. Exemplary algorithms of this type are presented in aforementioned U.S. patent applications Ser. Nos. 10/101,427 and 10/259,171.

The PMD vector Ω associated with cascaded delay lines 204, such as those illustrated in FIG. 2, equals the vector sum of the DGD vectors Ω_{PC} associated with the individual delay lines 204, projected into a single coordinate frame referenced to a physical point in the system. For example, all of the DGD vectors may be projected into the input coordinate frame, the output coordinate frame, or into the coordinate frame of the PMD monitor 208 before summation.

The effect of each compensation stage (i.e., the combination of a polarization controller 200 and a connected delay line 204) on the polarization state of incident light may be modeled as a Mueller rotation matrix R_{comp stage} on the Poincaré sphere 100. For example, considering the two-stage compensator of FIG. 2, the PMD vector of the compensator in the output frame after the second delay line 204² is:

Ω_{compensator}=Ω_{Delay Line 2}+R_{comp Stage 2}Ω_{Delay Line 1} (Eq. 2)

Accordingly, determining the required delay line orientations on the Poincaré sphere 100 and the physical polarization controller 200 settings to produce those orientations typically requires knowledge of the polarization transfer properties of the elements in the compensator to a high accuracy.

However, the polarization transfer properties of a delay line 204 constructed from a typical polarization-maintaining fiber (PMF) are sufficiently sensitive to temperature that a variation in temperature of less than one degree Centigrade will render Eq. 2 substantially unusable. Even standard free-space delay lines typically lack sufficient temperature stability to permit the use of Eq. 2 to deterministically compensate for PMD in a single measurement and compensation step.

The present invention provides an athermal delay line with sufficient thermal insensitivity to permit PMD compensation in a single deterministic step using Eq. 2. Specifically, an athermalized delay line whose polarization temperature properties vary at most by several degrees in retardance over a wide temperature range allows the use of Eq. 2 other than through an iterative feedback approach.

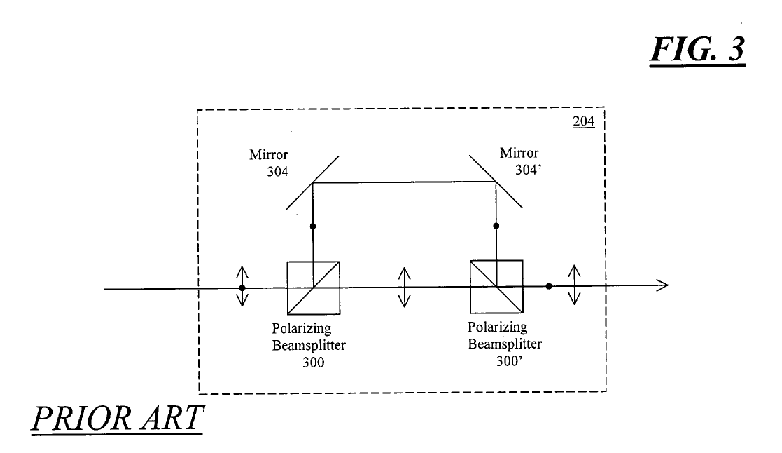

FIG. 3 illustrates a typical prior-art free space delay line 204. An incident light is split into two orthogonal linearly-polarized components using a polarizing beamsplitter 300. A first component is transmitted by the beamsplitter 300 along a first optical path to the second polarizing beamsplitter 300′. A second component is reflected by the beamsplitter 300 along a second optical path defined by mirrors 304, 304′ before it is recombined with the first component at polarizing beamsplitter 300′. The difference in path lengths between the paths traveled by the components results in a differential group delay (DGD).

This DGD will vary with temperature as the transmissive medium of the delay line and the mirror mounting hardware expands or contracts differentially with changes in temperature. Matching the group delays between the two paths is insufficient, as the material group indices and lengths are both a function of temperature. Optical glasses, for example, typically have a coefficient of thermal expansion (CTE) of approximately 5×10⁻⁶/° C. A 10° C. change in temperature therefore changes the length of 1 cm of glass by approximately 500 nm. For an index of approximately 1.5, this corresponds to a group delay change of 750 nm. At a typical telecommunications wavelength of 1550 nm, this group delay change corresponds to one-half wavelength, resulting in a 180° change in phase. This magnitude of change in the group delay between the two legs of the delay line is typically sufficient to render deterministic PMD compensation using Eq. 2 inoperative.

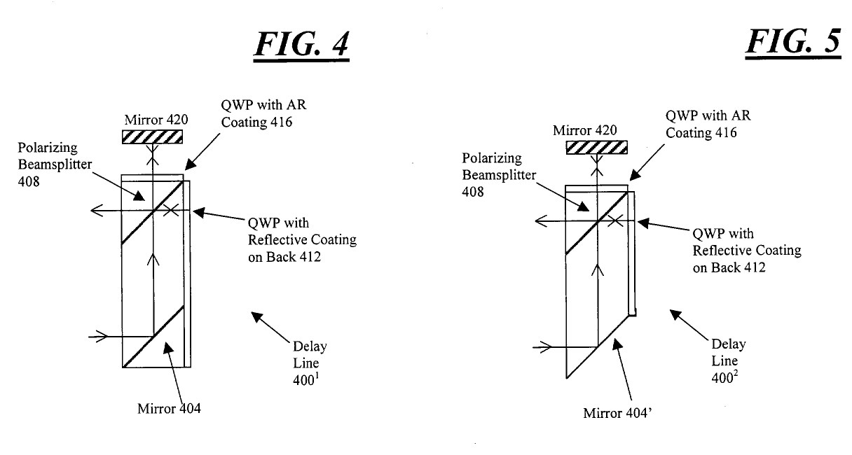

FIG. 4 presents a first embodiment of a delay line 400¹ in accord with the present invention. As illustrated, the delay line 400¹ (generally 400) includes a first mirror 404, a polarizing beam splitter 408, a reflective quarterwave plate 412, a transmissive quarterwave plate 416, and a second mirror 420. The basic glass components are constructed from a material that is optically transparent to light in a wavelength region of interest. Possible choices for light in the near-infrared telecommunications bands are fused silica, BK7 borosilicate glass, or silicon.

Typical mirrors 404, 420 include angled glass facets, beamsplitter cubes with reflective coatings on their hypotenuses, or free space mirrors. FIG. 5 presents an embodiment of the delay line that replaces the free space mirror 404 of the embodiment of FIG. 4 with an angled glass facet 404′.

A polarizing beamsplitter 408 may be fabricated from a basic glass component having a polarizing beamsplitter coating. The quarterwave plates 412, 416 may be constructed from any birefringent material such as calcite or quartz. The waveplates 412, 416 are typically zero-order waveplates, although three-quarter or five-quarter waveplates may be used to facilitate manufacture of the delay line 400. A reflective quarterwave plate 412 may be formed by sandwiching a quarterwave plate with a reflective coating or reflective backing.

In operation, a nominally collimated or slowly converging/diverging incident beam is reflected by a mirror 404 to a polarizing beamsplitter 408. The polarizing beamsplitter 408 resolves the light into its s and p polarized components, typically reflecting the s polarized component and transmitting the p polarized component. This configuration is convenient from a packaging standpoint, although the reflection from the first mirror 404 is not required for the operation of the invention.

The s component is reflected through the material to reflective quarterwave plate 412. The reflective quarterwave plate 412 is oriented with its fast and slow crystal axes nominally at 450 to the incident polarization state. As a result, the quarterwave plate 412 acts as a halfwave plate and rotates the polarization axis of the light by 90° as the light passes through the plate 412, is reflected, and traverses the plate 412 a second time. The reflected beam therefore returns to the polarizing beamsplitter 408 with nominally p polarization and is transmitted by the beamsplitter 408.

The p component is transmitted by the beamsplitter 408 through transmissive quarterwave plate 416. Quarterwave plate 416 is also oriented with its fast and slow crystal axes nominally at 45° to the incident polarization state. Therefore, quarterwave plate 416 also acts as a halfwave plate as the light passes through the plate 416, is reflected from mirror 420, and traverses the plate 416 a second time. The reflected beam therefore returns to the polarizing beamsplitter 408 with nominally s polarization and is reflected by the beamsplitter 408 and recombined with the s component.

The group delay of the two orthogonally polarized components through the delay line is the sum of the products of the group refractive indices n_{group} and physical path length d through each section of the optical path i:

$$GroupDelay = {\sum }_{i}^{} {n}_{{group}_{i}} {d}_{i} \qquad ( Eq . 3 )$$

Since the optical paths are identical to within optical and material fabrication tolerances, with the exception of the air path to the mirror 420, the differential group delay (DGD) between the two optical paths reduces to: 2nₐᵢᵣdₐᵢᵣ. Thus, the portions of the first optical path and second optical path that are not relied upon to implement the differential group delay—whether they utilize common components or separate components—may be formed from thermally sensitive materials, thermally insensitive materials, or a combination thereof, as long as the thermal sensitivity is balanced between the two paths.

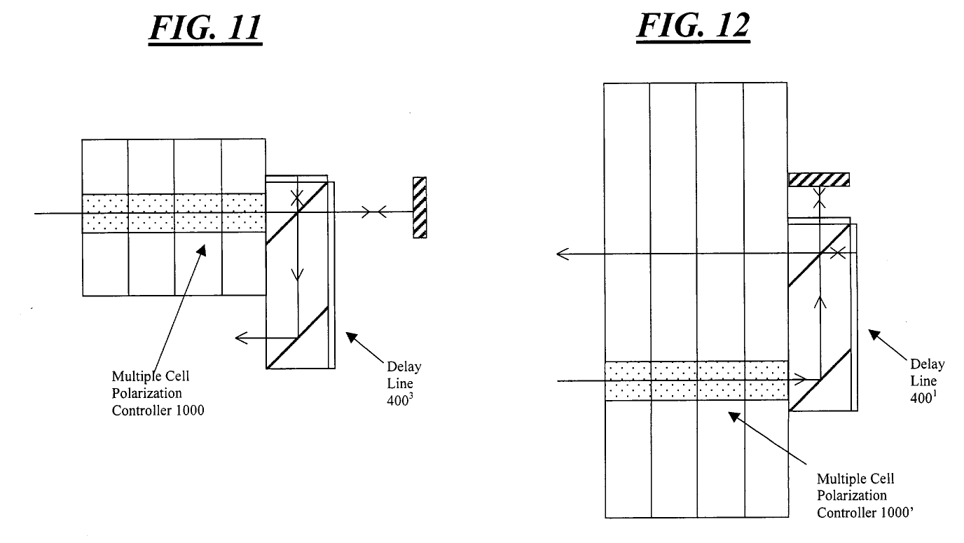

In the embodiment of the invention illustrated in FIG. 4, the identity of the materials between the portions of the two paths up through the quarterwave plates 412, 416 results in a “common path” configuration, where the two material portions of the delay lines are equal over a range of temperatures to a high accuracy. The metering spacer between the mirror 404 and the beamsplitter 408 is formed from an ultralow expansion material such as SCHOTT ZERODUR, CORNING ULE, OR INVAR The spacer may be located on the edges of the mirror 404 and the beamsplitter 408 between the two plane parallel surfaces at the edges of the parts; this allows tilting of the mirror to co-boresight the two delay paths at the output port. The further embodiments of the athermal delay line of the present invention illustrated in FIGS. 5-17 may also utilize this low-expansion metering spacer.

The only “non-common” path between the two optical paths—the path to the mirror 420—may be formed using a spacer of an ultralow expansion material. The path to the mirror 420 may be air or free space, provided that the individual components are metered with a spacer formed from an ultralow expansion material or a material that is otherwise thermally insensitive. This ensures that the only “non-common” path between the two optical paths—the air path to the mirror 420, which implements the differential group delay in this embodiment—is held constant to less than 10 nanometers over changes in temperature ranging tens of degrees. This provides sufficient accuracy to allow for the use of Eq. 2 for deterministic PMD compensation.

Eliminating adhesives and epoxies from the metering path between the mirror 404 and the beamsplitter 408 further bolsters the temperature-independence of the DGD of the delay line 400¹. Thermal expansion of adhesives and epoxies in the metering path is otherwise sufficient to deleteriously affect the aforementioned athermal properties of the delay line. The further embodiments of the athermal delay line of the present invention illustrated in FIGS. 5-17 may also eliminate epoxies and adhesives to bolster the athermal properties of the delay line of the present invention.

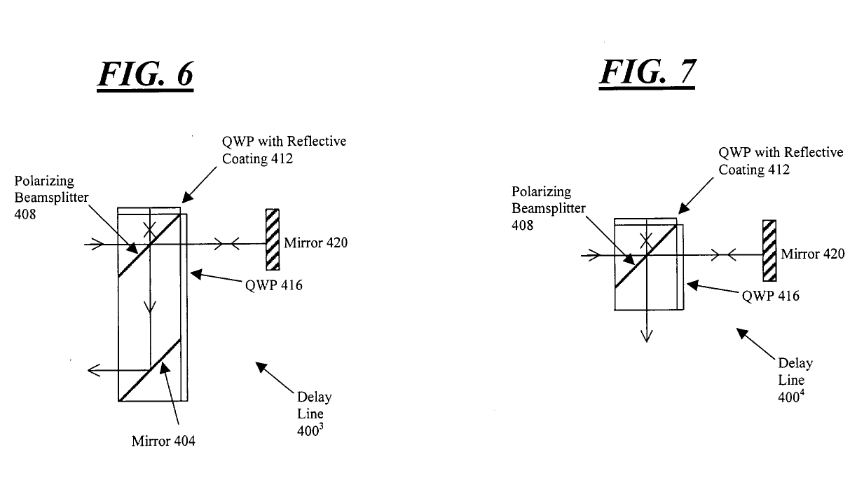

FIG. 6 presents the embodiment of FIG. 4 with the order of the fold mirror 404 and the delay path reversed. In operation, a nominally collimated or slowly converging/diverging incident beam is received by the polarizing beamsplitter 408. The polarizing beamsplitter 408 resolves the light into its s and p polarizations, reflecting the s polarized component and transmitting the p polarized component.

The s component is reflected to reflective quarterwave plate 412. The reflective quarterwave plate 412 is oriented with its fast and slow crystal axes nominally at 45° to the incident polarization state. As a result, the quarterwave plate 412 acts as a halfwave plate and rotates the polarization axis of the light by 90° as the light passes through the plate 412, is reflected, and traverses the plate 412 a second time. The reflected beam therefore returns to the polarizing beamsplitter 408 with nominally p polarization and is transmitted by the beamsplitter 408.

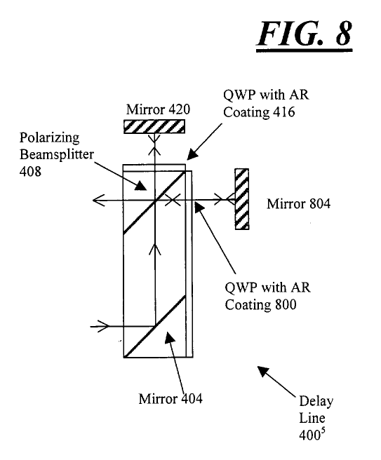

The p component is transmitted by the beamsplitter 408 through transmissive quarterwave plate 416. Quarterwave plate 416 is also oriented with its fast and slow crystal axes nominally at 45° to the incident polarization state. Therefore, quarterwave plate 416 also acts as a halfwave plate as the light passes through the plate 416, is reflected from mirror 420, and traverses the plate 416 a second time. The reflected beam returns to the polarizing beamsplitter 408 with nominally s polarization and is reflected by the beamsplitter 408. The reflected beam recombines with the s component, reflects from the fold mirror 404, and exits the delay line 400³. As FIG. 7 illustrates, the fold mirror 404 may also be eliminated in its entirety, with the delay line 400⁴ otherwise operating as described in connection with FIG. 6. The reflective quarterwave plate 412 may be replaced by the combination of a second transmissive quarterwave plate 800 and a second mirror 804; one such embodiment is presented in FIG. 8.

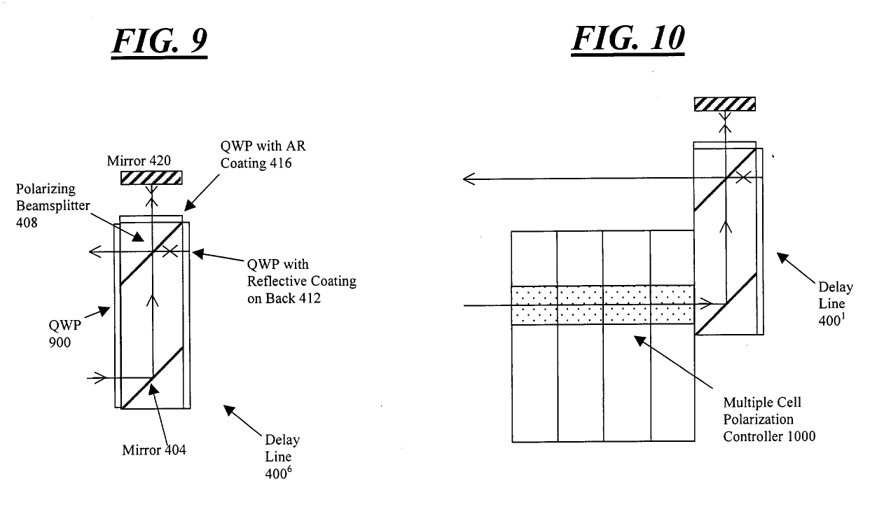

Another embodiment of the athermal delay line includes a quarterwave plate at the input, the output, or both of the athermal delay line. FIG. 9 presents the delay line embodiment of FIG. 4 in this configuration with a quarterwave plate 424 at its input and output ports, although any athermal delay line in accord with the present invention may be similarly configured. The quarterwave plate 424 is oriented with its crystal axes at 45°, converting the linear delay line eigenstates to circular polarization in input and/or output space.

The athermal delay line devices illustrated in FIGS. 4-9 may be directly applied to a first or second-order PMD compensator, such as those described in aforementioned U.S. patent application Ser. Nos. 10/218,681 and 10/259,171. Referring to the second-order compensator of FIG. 2 as an illustrative example, an athermal delay line 400 in accord with the present invention may be located in a free space optical path between the two polarization controllers 200¹, 200². In general, the athermal delay line 400 of the present invention may be applied to higher-order PMD compensators in the same manner, i.e., by siting an athermal delay line between two adjacent polarization controller stages 200^{N}, 200^{N+1}.

When the polarization controller has an accessible planar surface, any athermal delay line 400 in accord with the present invention (e.g., athermal delay lines 400¹, 400³, etc.) may be affixed directly to the polarization controller using, for example, epoxy or other adhesive to form a solid state compensation stage, as illustrated in FIGS. 10-12. Typical polarization controllers include both nematic and ferroelectric liquid crystals, as well as stressed glass/fused silica waveplates.

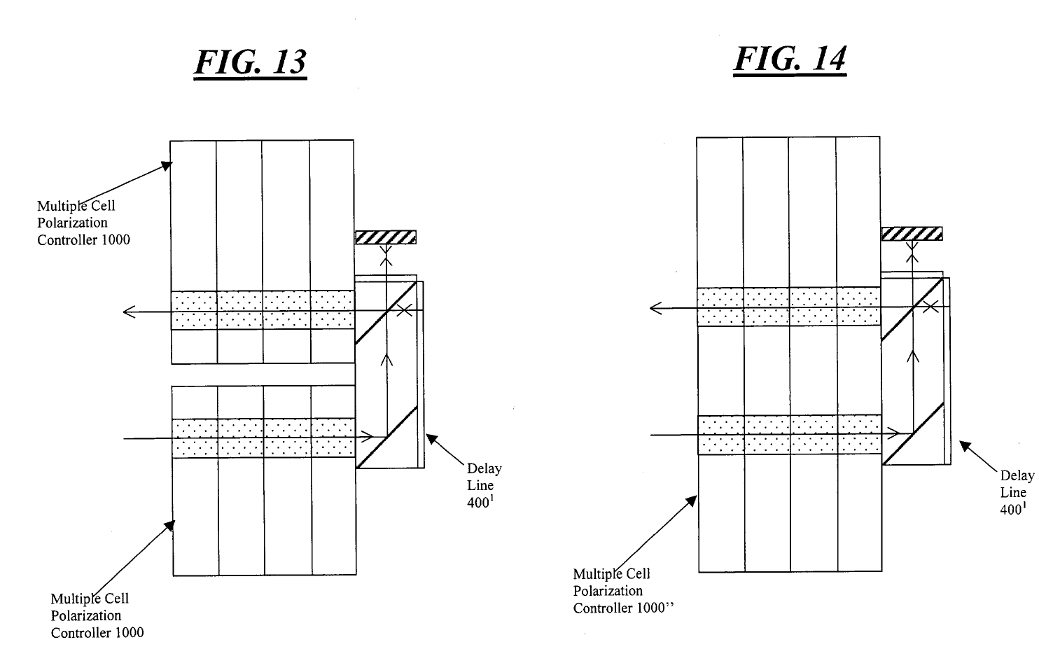

FIG. 13 illustrates another controller/delay line combination suitable for use with higher-order PMD compensators. This embodiment utilizes a folded-U version of the athermal delay line 400 to form a retro optical path between the first polarization controller 1000 and the second polarization controller 1000′.

FIG. 14 illustrates a combination of a delay line 400 and a multi-cell polarization controller 1000″0 suited to PMD compensators incorporating multiple polarization controllers in a single stack. In this case, the first and second polarization controllers (e.g., polarization controllers 200¹, 200² of FIG. 2) are integrated into a single monolithic component 1000″.

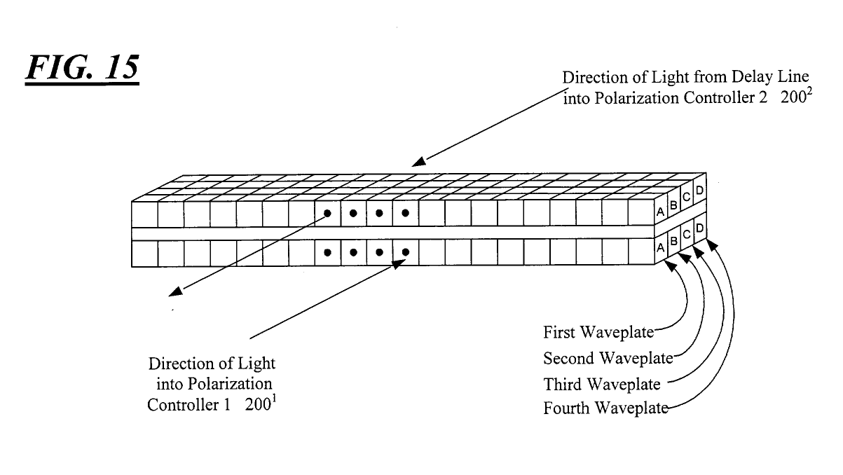

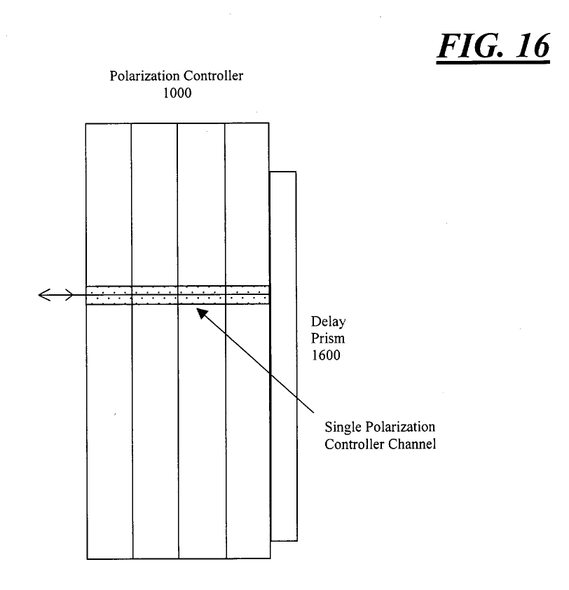

The athermal delay line of the present invention may also be used with multichannel PMD compensators, such as those described in aforementioned U.S. patent application Ser. Nos. 10/218,681 and 10/259,171. The polarization controllers of these compensators (e.g., controllers 200¹, 200² of FIG. 2) are implemented as pixelized arrays, with one pixel per optical channel in each array. One such polarization controller, illustrated in FIG. 15, is fabricated from waveplates with limited rotation or retardation ranges in at least four stages to allow reset-free operation using PMD compensation algorithms. The athermal delay line may then be extended in the along-array direction as illustrated in the side view of FIG. 16, with each data channel passing from a first polarization controller pixel through the athermal delay line to a matching second polarization controller pixel.

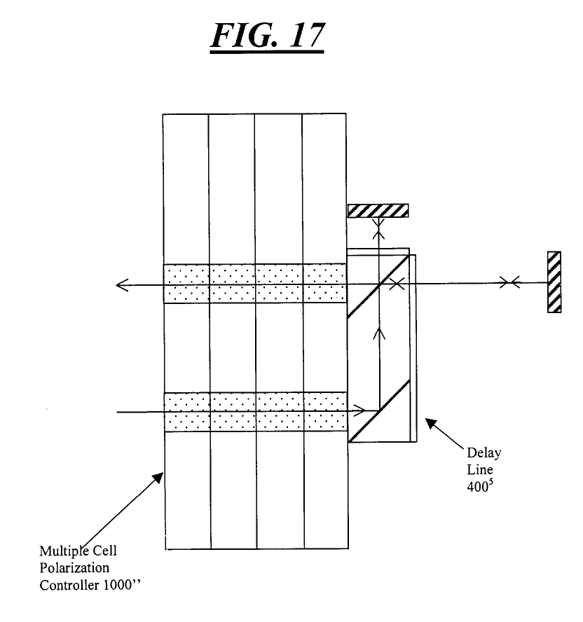

Any of the athermalized delay line embodiments of FIGS. 4-14 may be modified by the introduction of a second athermalized spacer, with the net delay given by the difference of the two athermalized paths. For example, FIG. 17 shows the embodiment of FIG. 14 having a second athermalized path.

Many alterations and modifications may be made by those having ordinary skill in the art without departing from the spirit and scope of the invention. Therefore, it must be expressly understood that the illustrated embodiments have been shown only for purposes of example and should not be taken as limiting the invention. The invention should therefore be understood to include, for example, all equivalent elements for performing substantially the same function in substantially the same way to obtain substantially the same result, even though not identical in other respects to what is shown and described in the above illustrations. Possible variations include, but are not limited to, additional folds and glass plates, the use of roof and corner cubes for reflections, and variations in optical and spacer materials.

What is claimed is:

1. An athermal delay line comprising:
a first optical path; and
a second optical path,
wherein the difference in optical path length between the first optical path and the second optical path is thermally insensitive.

2. The delay line of claim 1 wherein an overlapping portion of the first optical path and the second optical path comprises a polarizing beam splitter.

3. The delay line of claim 2 wherein the overlapping portion of the first optical path and the second optical path further comprises a fold mirror.

4. The delay line of claim 3 wherein the fold mirror is selected from the group consisting of angled glass facets, a beamsplitter cube with a reflective coating on its hypotenuse, and a free space mirror.

5. The delay line of claim 1 wherein a portion of the first optical path that does not overlap with the second optical path comprises a reflecting quarterwave plate.

6. The delay line of claim 5 wherein the reflecting quarterwave plate comprises a quarterwave plate in non-adjacent proximity to a reflector.

7. The delay line of claim 5 wherein the reflecting quarterwave plate comprises a quarterwave plate having a reflective coating.

8. The delay line of claim 5 wherein a portion of the second optical path that does not overlap with the first optical path comprises a reflecting quarterwave plate.

9. The delay line of claim 8 wherein the reflecting quarterwave plate comprises a quarterwave plate in non-adjacent proximity to a reflector.

10. The delay line of claim 8 wherein the reflecting quarterwave plate comprises a quarterwave plate having a reflective coating.

11. The delay line of claim 1 wherein an overlapping portion of the first optical path and the second optical path further comprises a transmissive quarterwave plate placed at the entrance, exit, or both, of the overlapping portion.

12. The delay line of claim 1 wherein a portion of the second optical path that does not overlap with the first optical path comprises an air gap.

13. An apparatus for delaying a light signal, comprising:
a polarizing beamsplitter;
a first reflecting quarterwave plate in optical communication with the polarizing beamsplitter, forming a first optical path; and
a second reflecting quarterwave plate in optical communication with the polarizing beamsplitter, forming a second optical path,
wherein the difference in optical path length between the first optical path and the second optical path is thermally insensitive.

14. The apparatus of claim 13 wherein an overlapping portion of the first optical path and the second optical path further comprises a fold mirror.

15. The apparatus of claim 14 wherein the fold mirror is selected from the group consisting of angled glass facets, a beamsplitter cube with a reflective coating on its hypotenuse, and a free space mirror.

16. The apparatus of claim 13 wherein at least one of the reflecting quarterwave plates comprises a quarterwave plate in non-adjacent proximity to a reflector.

17. The apparatus of claim 14 wherein at least one of the reflecting quarterwave plates comprises a quarterwave plate having a reflective coating.

18. The apparatus of claim 14 wherein an overlapping portion of the first optical path and the second optical path further comprises a transmissive quarterwave plate placed at the entrance, exit, or both, of the overlapping portion.

19. The apparatus of claim 14 wherein a portion of the second optical path that does not overlap with the first optical path comprises an air gap.

20. A PMD compensation stage comprising:
a polarization controller; and
an athermal delay line in optical communication with the polarization controller, the delay line comprising:
a first optical path; and
a second optical path,
wherein the difference in optical path length between the first optical path and the second optical path is thermally insensitive.

21. A multichannel PMD compensation stage comprising:
a multichannel polarization controller; and
a multichannel athermal delay line in optical communication with the polarization controller, the delay line comprising:
a first optical path; and
a second optical path,
wherein the difference in optical path length between the first optical path and the second optical path is thermally insensitive.
